(19) United States
(12) Patent Application Publication
(10) Pub. No.: US 2013/0124146 A1
(43) Pub. Date: May 16, 2013

(54) SERVER AND METHOD FOR MANAGING GREENHOUSE GAS EMISSIONS INVESTIGATIONS

(71) Applicant: HON HAI PRECISION INDUSTRY CO., LTD., New Taipei (TW)

(72) Inventor: CHEN-WEI HSU, New Taipei (TW)

(73) Assignee: HON HAI PRECISION INDUSTRY CO., LTD., New Taipei (TW)

(21) Appl. No.: 13/670,481

(22) Filed: Nov. 7, 2012

(30) Foreign Application Priority Data
Nov. 16, 2011 (TW) 100141799

(51) Int. Cl. G06F 17/40; G06F 15/00

(52) U.S. Cl. 702/187

(57) ABSTRACT

In a method for investigating greenhouse gas emissions, and managing the investigation, an investigation mode of greenhouse gasses emitted by an organization is applied, and an organization boundary, an emission boundary, and a base year of the investigation mode is set. Collection parameters of the greenhouse gas emissions are acquired according to the investigation mode, and data about the greenhouse gas emissions is collected according to the collection parameters. The collected data is analyzed and a report is created according to the analysis of the collected data.

### BACKGROUND

1. Technical Field

Embodiments of the present disclosure generally relate to data management technology, and particularly to a server and a method for managing greenhouse gas emissions investigations.

2. Description of Related Arts

To control and reduce emissions of greenhouse gases, many organizations, including governments, investigate greenhouse gases emitted from industrial factories. However, because a massive amount of data about the greenhouse gases needs to be collected and calculated, it is difficult to investigate the greenhouse gases manually.

### BRIEF DESCRIPTION OF THE DRAWINGS

FIG. 1 is a schematic diagram of one embodiment of a management server.

FIG. 2 is a block diagram of one embodiment of function modules of a management unit.

FIG. 3 is a flowchart of one embodiment of a method for managing greenhouse gas emissions investigations.

FIG. 4 is a flowchart detailing one embodiment of step S14 in FIG. 3.

FIG. 5A-5M are exemplary embodiments of operation interfaces.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

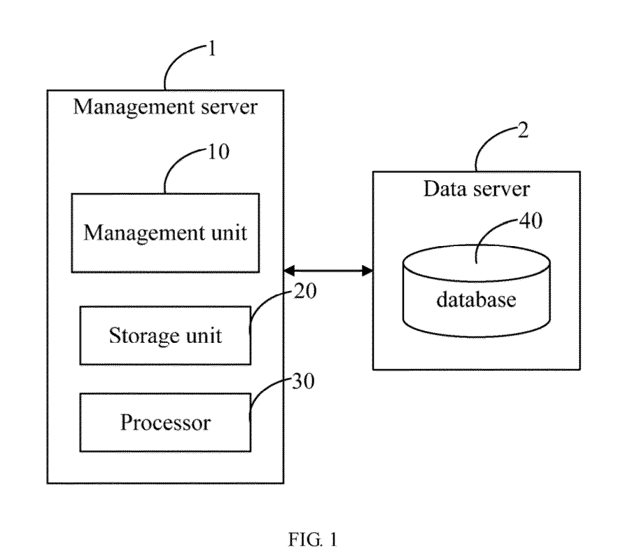

FIG. 1 is a schematic diagram of one embodiment of a management server 1. In the embodiment, the management server 1 includes a management unit 10, a storage unit 20, and a processor 30. The management server 1 is electrically connected to a data server 2. The data server 2 includes a database 40. In other embodiments, the data server 2 may be merged with the management server 1.

The management unit 10 manages greenhouse gas emissions investigations from an organization. For example, the organization may be a company or a factory, which may include one or more branches, and each branch may include one or more departments; or the organization may be a branch or a department. For example, a company may include three branches. The greenhouse gases emitted include CO₂, CH₄, N₂O, HFCs, PFCs, and SF₆. In detail, the management unit 10 collects data about the greenhouse gases emitted from the organization, and an emission amount of CO₂ from the organization is calculated, the collected data and results of calculation are analyzed, and an investigation report according to the analysis is issued. The database 40 stores the collected data, the results of the calculation, and the investigation report.

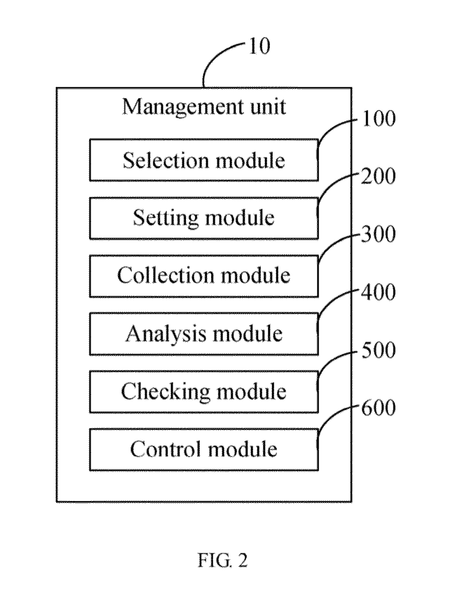

In one embodiment, the management unit 10 may include one or more function modules (as shown in FIG. 2). The one or more function modules may comprise computerized code in the form of one or more programs that are stored in the storage unit 20, and executed by the processor 30 to provide the functions of the management unit 10. The storage unit 20 is a dedicated memory, such as an EPROM or a flash memory.

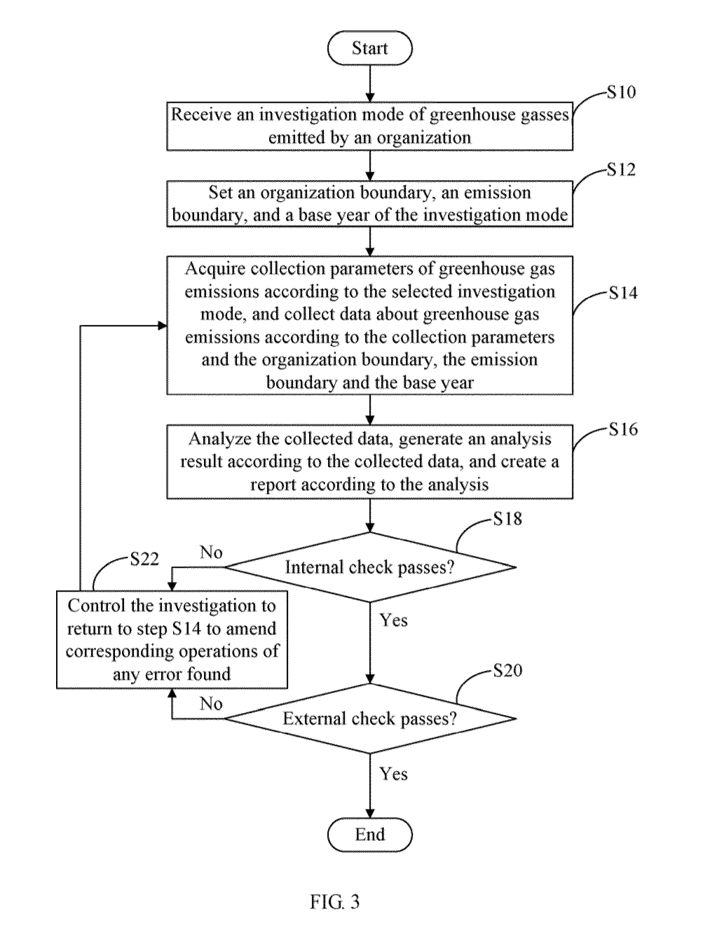

FIG. 2 is a block diagram of one embodiment of the function modules of the management unit 10. In one embodiment, the management unit 10 includes a selection module 100, a setting module 200, a collection module 300, an analysis module 400, a checking module 500, and a control module 600. A description of the functions of the modules 100-600 is given with reference to FIG. 3.

FIG. 3 is a flowchart of one embodiment of a method for managing greenhouse gas emissions investigations. Depending on the embodiment, additional steps may be added, others removed, and the ordering of the steps may be changed, all steps progress in even numbers only.

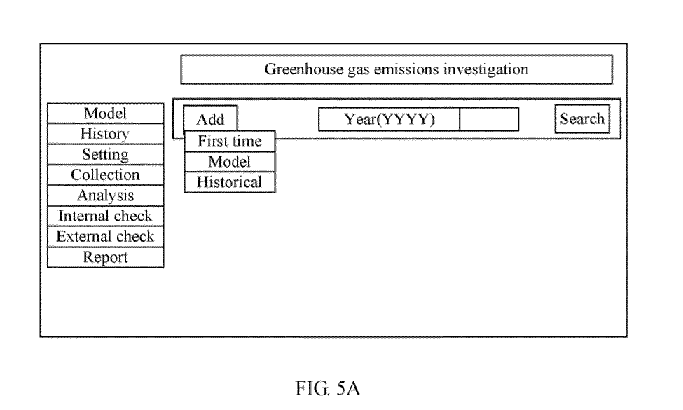

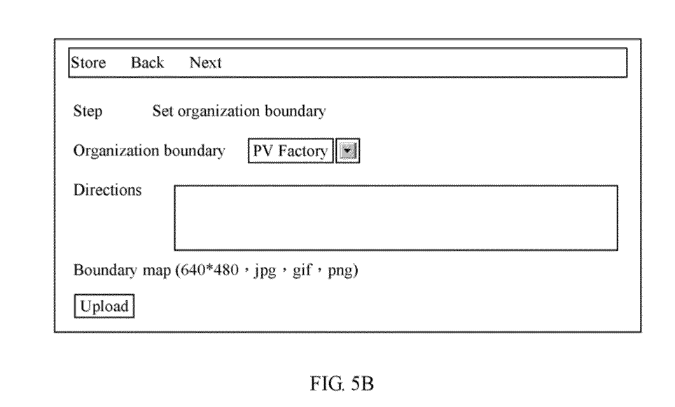

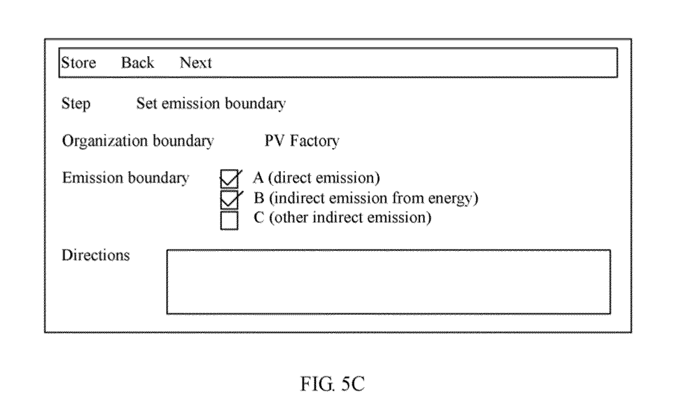

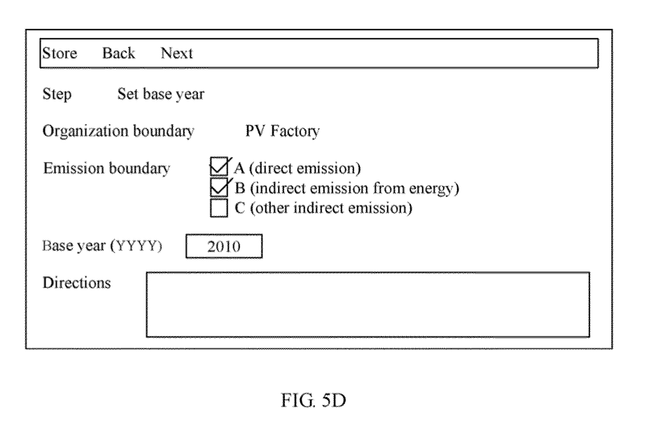

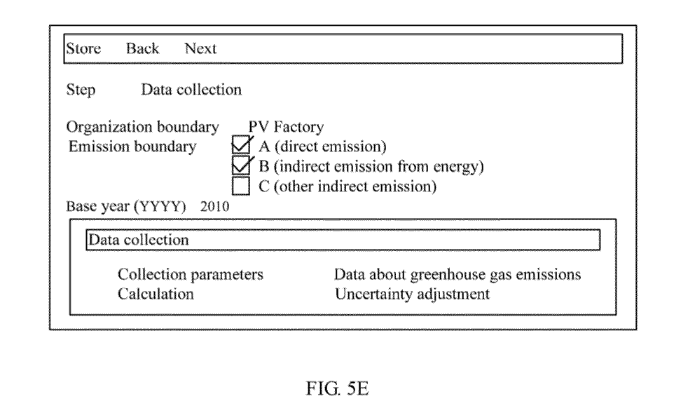

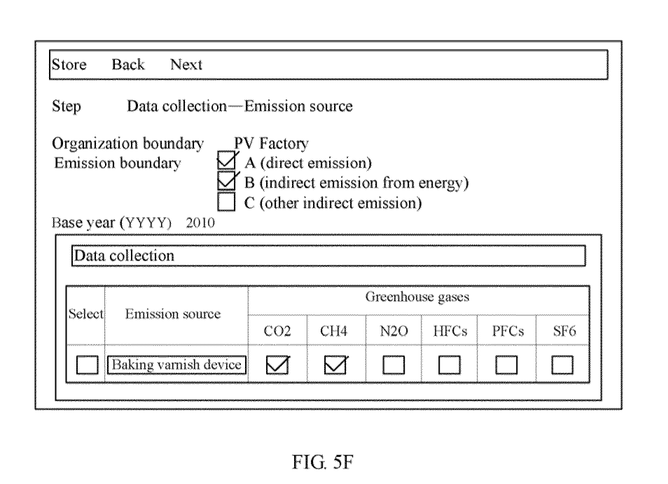

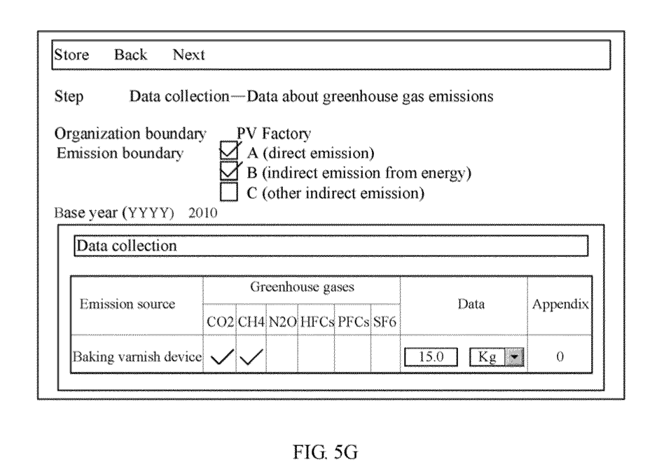

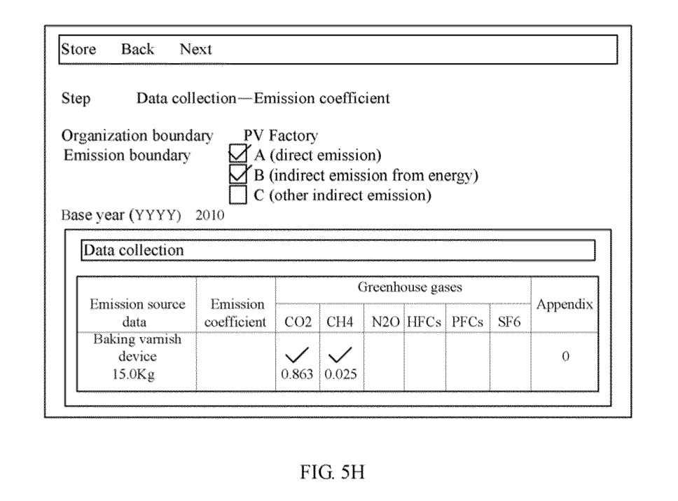

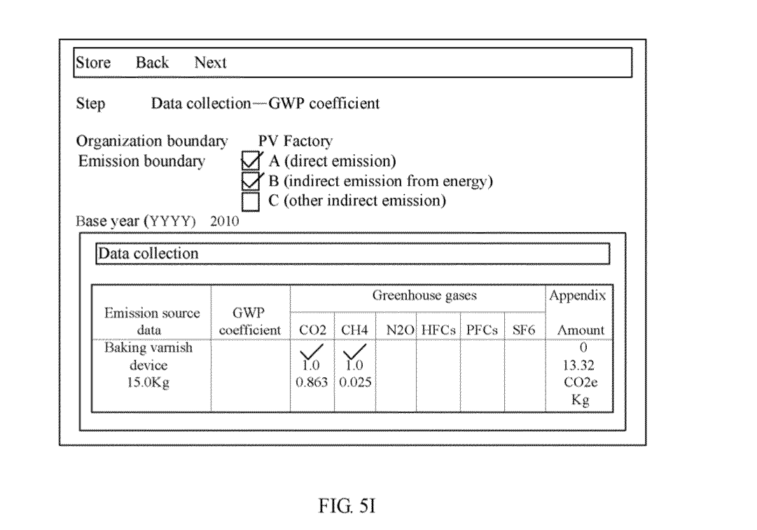

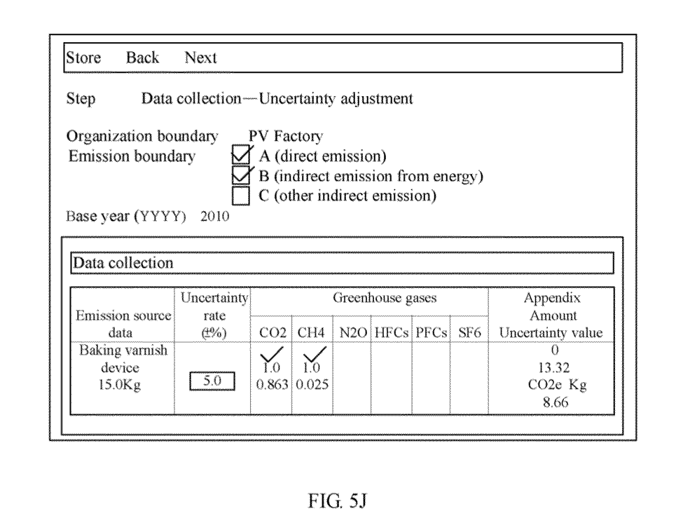

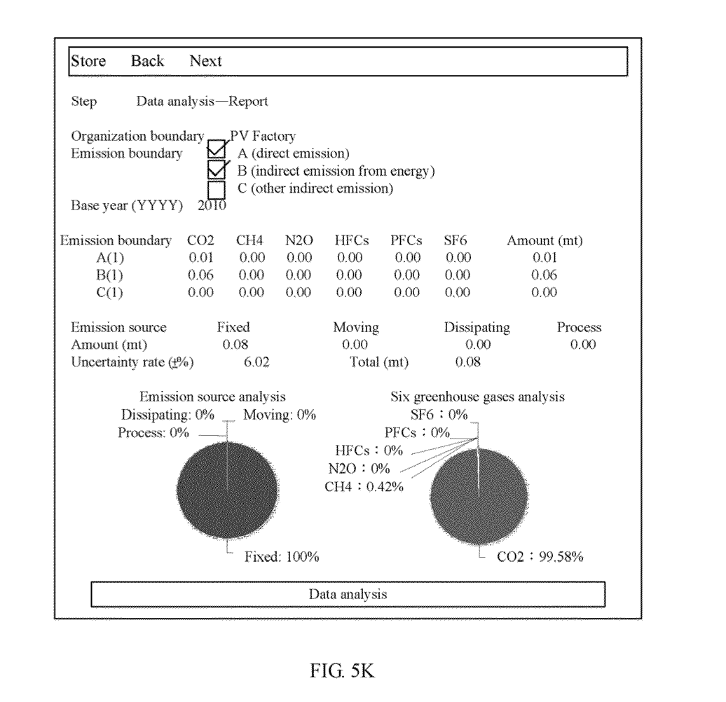

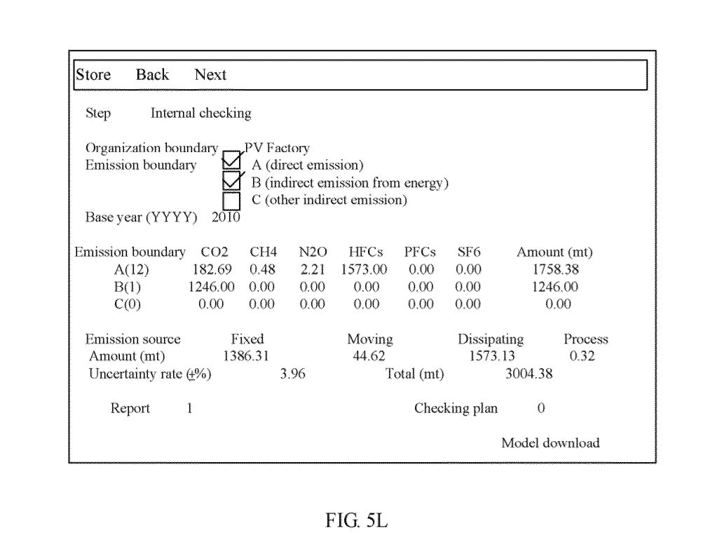

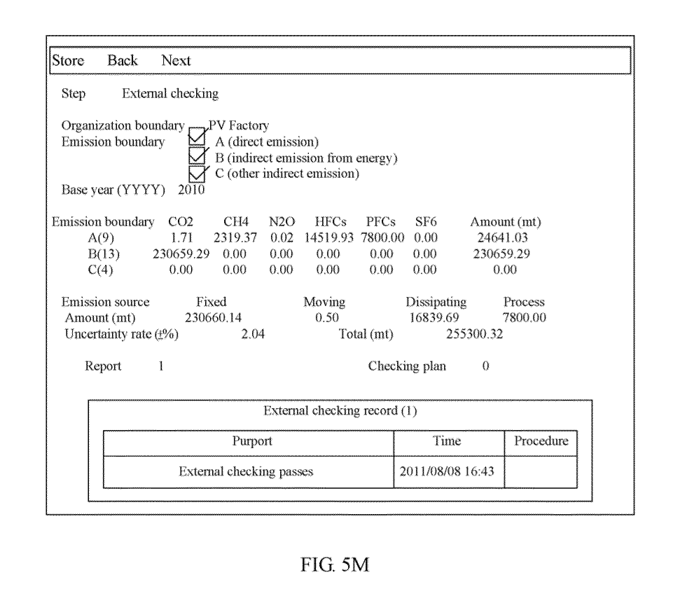

In step S10, the selection module 100 receives an investigation mode of the greenhouse gasses emitted by an organization. The investigation mode, in one embodiment, may be user-selected, and include a first time investigation mode, a model investigation mode, or a historical investigation mode (as shown in FIG. 5A). If the first time investigation mode is selected, step S12 is implemented. If the model investigation mode is selected, the selection module 100 reads data of a selected model from the database 40, then step S12 is implemented. If the historical investigation mode is selected, the selection module 100 reads selected historical data from the database 40, then step S12 is implemented.

In step S12, the setting module 200 sets an organization boundary, an emission boundary, and a base year of the investigation mode. In the embodiment, the organization boundary is a range of the greenhouse gases emitted by an organization, such as a factory or a department of the factory (as shown in FIG. 5B). The emission boundary is an emission type or types applicable to the organization, including direct emissions, indirect emissions from energy, and other indirect emissions (as shown in FIG. 5C). The base year is a historical year, the present amount of CO₂ calculated may be compared with figures for the base year (as shown in FIG. 5D).

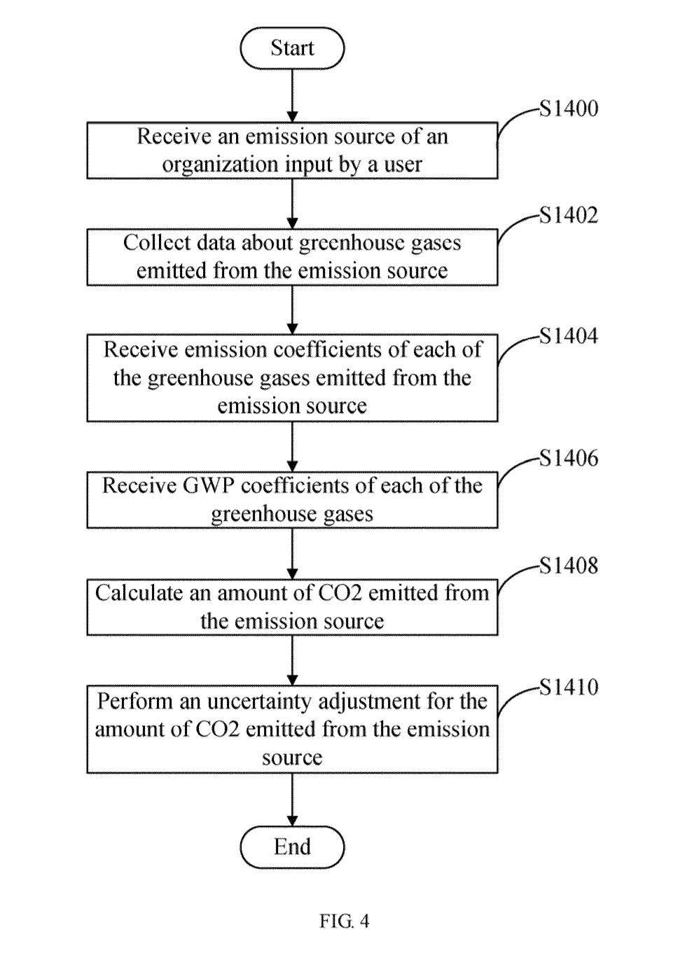

In step S14, the collection module 300 acquires collection parameters of the greenhouse gas emissions according to the selected investigation mode, and collects data about the greenhouse gas emissions according to the collection parameters and the organization boundary, the emission boundary, and the base year (as shown in FIG. 5E-5J). The collection parameters include emission sources, emission coefficients, and global warming potential (GWP) coefficients, for example. A description is given below with reference to FIG. 4.

In the embodiment, if the first time investigation mode is selected, in step S10, the collection module 300 acquires collection parameters input by the user. If the model investigation mode in step S10 is selected, the collection module 300 acquires collection parameters from the model. If the historical investigation mode in step S10 is selected, the collection module 300 acquires collection parameters from the historical data.

In step S16, the analysis module 400 analyzes the collected data, generates an analysis result according to the collected data, and creates a report according to the analysis. In some embodiments, the analysis module 400 may analyze a trend of the CO₂ emissions, or the amounts of CO₂ emitted from each emission source, for example. The report may include tables, graphs, maps, or other types of presentation (as shown in FIG. 5K).

In step S18, the checking module 500 prompts internal checkers (e.g., data auditors) to check data in the report (as shown in FIG. 5L). The internal checkers belong to the organization, such as employees in a factory. The data in the report has been obtained according to steps S12-S16. If the internal checkers find any error in the report, the check halts, and step S22 is implemented. If the internal checkers find no error in the report, step S20 is implemented after the check.

In step S20, the checking module 500 prompts external checkers to check data in the report (as shown in FIG. 5M). The external checkers are outside the organization, such as an environment consultancy firm. If the external checkers find any error in the report, the check halts, and step S22 is implemented. If the external checkers find no error in the report, the procedure ends after the external check.

In step S22, the control module 600 controls the investigation to return to step S14 to amend corresponding operations of any error found. For example, if the internal checkers find that a record of an amount of CO₂ emitted from a fixed emission source is erroneous, as in FIG. 5L, the control module 600 controls the investigation to return to operations of collecting data about greenhouse gases emitted from the fixed emission source and recalculate the amount of CO₂ emitted from the fixed emission source.

FIG. 4 is a flowchart detailing one embodiment of step S14 in FIG. 3. Depending on the embodiment, additional steps may be added, others removed, and the ordering of the steps may be changed, all substeps progressing in even numbers only.

In step S1400, the collection module 300 receives an emission source of an organization input by a user (as shown in FIG. 5F).

In step S1402, the collection module 300 collects data about greenhouse gases emitted from the emission source (as shown in FIG. 5G). For example, the collection module 300 collects the amount of greenhouse gases emitted from the emission source.

In step S1404, the collection module 300 receives emission coefficients of each of the greenhouse gases emitted from the emission source (as shown in FIG. 5H). The emission coefficients express relationships between the greenhouse gases and the emission source. For example, the emission coefficient may be an amount of CO₂ emitted when one liter of gasoline is burned.

In step S1406, the collection module 300 receives GWP coefficients of each of the greenhouse gases (as shown in FIG. 5I). In the embodiment, the collection module 30 automatically acquires the emission coefficients and GWP coefficients from the Intergovernmental Panel on Climate Change (IPCC). If the model investigation mode or the historical investigation mode is selected in step S10, the emission coefficients and GWP coefficients can be acquired from the model or from the historical data.

In step S1408, the collection module 300 calculates an amount of CO₂ emitted from the emission source. In the embodiment, an emitted amount of each greenhouse gas equals the amount of raw materials emitting greenhouse gases of the emission source multiplied by corresponding emission coefficient of the greenhouse gas. The amount of CO₂ emitted from the emission source equals the emitted amount of each greenhouse gas multiplied by the GWP coefficient of the greenhouse gas.

As shown in FIG. 5I, an amount of raw materials emitting greenhouse gases of a baking varnish device as a emission source is 15.0 kilograms. The greenhouse gases emitted include CO₂ and CH₄, where the emission coefficient of CO₂ is 0.863, the emission coefficient of CH₄ is 0.0025, the GWP coefficient of CO₂ is 1, and the GWP coefficient of CH₄ is 1. The collection module 300 calculates that the amount of CO₂ emitted from a baking varnish device in FIG. 5I is 15.0*0.863*1+15.0*0.0025*1=13.32 kilograms.

In step S1410, the collection module 300 performs an uncertainty adjustment for the amount of CO₂ emitted from the emission source (as shown in FIG. 5J). In the embodiment, the collection module 300 applies an uncertainty rate input by the user, or automatically inputs a preset uncertainty rate (such as 5%), and calculates a permitted uncertainty value of the amount of CO₂ emitted from the emission source.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of an electronic device, the method comprising:
(a) receiving an investigation mode of greenhouse gasses emitted by an organization;
(b) setting an organization boundary, an emission boundary, and a base year of the investigation mode;
(c) acquiring collection parameters of the greenhouse gas emissions according to the investigation mode, and collecting data about the greenhouse gas emissions according to the collection parameters and the organization boundary, the emission boundary and the base year; and
(d) analyzing the collected data and creating a report according to the analysis of the collected data.

2. The method as claimed in claim 1, wherein after step (d) the method further comprises:
prompting internal checkers and external checkers to check data in the report; and
controlling the investigation to return to step (c) to amend corresponding operations of any error found.

3. The method as claimed in claim 1, wherein step (c) further comprises:
receiving an emission source of the organization;
collecting data about greenhouse gases emitted from the emission source;
receiving emission coefficients of each of the greenhouse gases emitted from the emission source;
receiving global warming potential (GWP) coefficients of each of the greenhouse gases;
calculating an amount of CO₂ emitted from the emission source; and
performing an uncertainty adjustment for the amount of CO₂ emitted from the emission source.

4. The method as claimed in claim 3, wherein an emitted amount of each greenhouse gas equals an amount of raw materials emitting greenhouse gases of the emission source multiplied by corresponding emission coefficient of the greenhouse gas; and the amount of CO₂ emitted from the emission source equals the emitted amount of each greenhouse gas multiplied by the GWP coefficient of the greenhouse gas.

5. The method as claimed in claim 1, wherein:
the investigation mode is a first time investigation mode, a model investigation mode, or a historical investigation mode;
the collection parameters are input by a user in response that the first time investigation mode is selected;
the collection parameters are acquired from a model in response that the model investigation mode is selected; or
the collection parameters are acquired from historical data in response that the historical investigation mode is selected.

6. A non-transitory storage medium storing a set of instructions, the set of instructions being executed by a processor of an electronic device, to perform a method comprising:
(a) receiving an investigation mode of greenhouse gasses emitted by an organization;
(b) setting an organization boundary, an emission boundary, and a base year of the investigation mode;
(c) acquiring collection parameters of the greenhouse gas emissions according to the investigation mode, and collecting data about the greenhouse gas emissions according to the collection parameters and the organization boundary, the emission boundary and the base year; and
(d) analyzing the collected data and creating a report according to the analysis of the collected data.

7. The non-transitory storage medium as claimed in claim 6, wherein after step (d) the method further comprises:
prompting internal checkers and external checkers to check data in the report; and
controlling the investigation to return to step (c) to amend corresponding operations of any error found.

8. The non-transitory storage medium as claimed in claim 6, wherein step (c) further comprises:
receiving an emission source of the organization;
collecting data about greenhouse gases emitted from the emission source;
receiving emission coefficients of each of the greenhouse gases emitted from the emission source;
receiving global warming potential (GWP) coefficients of each of the greenhouse gases;
calculating an amount of CO₂ emitted from the emission source; and
performing an uncertainty adjustment for the amount of CO₂ emitted from the emission source.

9. The non-transitory storage medium as claimed in claim 8, wherein an emitted amount of each greenhouse gas equals an amount of raw materials emitting greenhouse gases of the emission source multiplied by corresponding emission coefficient of the greenhouse gas; and the amount of CO₂ emitted from the emission source equals the emitted amount of each greenhouse gas multiplied by the GWP coefficient of the greenhouse gas.

10. The non-transitory storage medium as claimed in claim 6, wherein:
the investigation mode is a first time investigation mode, a model investigation mode, or a historical investigation mode;
the collection parameters are input by a user in response that the first time investigation mode is selected;
the collection parameters are acquired from a model in response that the model investigation mode is selected; or
the collection parameters are acquired from historical data in response that the historical investigation mode is selected.

11. An electronic device, the electronic device comprising:
a storage unit;
at least one processor;
one or more programs that are stored in the storage unit and are executed by the at least one processor, the one or more programs comprising:
a selection module that receives an investigation mode of greenhouse gasses emitted by an organization;
a setting module that sets an organization boundary, an emission boundary, and a base year of the investigation mode;
a collection module that acquires collection parameters of the greenhouse gas emissions according to the investigation mode, and collects data about the greenhouse gas emissions according to the collection parameters and the organization boundary, the emission boundary and the base year; and
an analysis module that analyzes the collected data and creates a report according to the analysis of the collected data.

12. The electronic device as claimed in claim 11, wherein one or more programs further comprises:
a checking module that prompts internal checkers and external checkers to check data in the report; and
a control module that controls the collection module to amend corresponding operations of any error found.

13. The electronic device as claimed in claim 11, wherein the collection module further:
receives an emission source of the organization;
collects data about greenhouse gases emitted from the emission source;
receives emission coefficients of each of the greenhouse gases emitted from the emission source;
receives global warming potential (GWP) coefficients of each of the greenhouse gases;
calculates an amount of CO₂ emitted from the emission source; and
performs an uncertainty adjustment for the amount of CO2 emitted from the emission source.

14. The electronic device as claimed in claim 13, wherein an emitted amount of each greenhouse gas equals an amount of raw materials emitting greenhouse gases of the emission source multiplied by corresponding emission coefficient of the greenhouse gas; and the amount of CO₂ emitted from the emission source equals the emitted amount of each greenhouse gas multiplied by the GWP coefficient of the greenhouse gas.

15. The electronic device as claimed in claim 11, wherein:
the investigation mode includes a first time investigation mode, a model investigation mode, or a historical investigation mode;
the collection parameters are input by a user in response that the first time investigation mode is selected;
the collection parameters are acquired from a model in response that the model investigation mode is selected; or
the collection parameters are acquired from historical data in response that the historical investigation mode is selected.
